(19) United States
(12) Patent Application Publication
(10) Pub. No.: US 2007/0058584 A1
(43) Pub. Date: Mar. 15, 2007

(54) Techniques to transmit and duplex with channel knowledge at a base station

(76) Inventor: Ilan Sutskover, Hadera (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/225,303

(22) Filed: Sep. 12, 2005

(51) Int. Cl. H04J 3/00

(52) U.S. Cl. 370/330

(57) ABSTRACT

An embodiment of the present invention provides an apparatus, comprising a base station employing a duplexing technique that allows simultaneous transmission and reception on a plurality of frequency such that in each transmit time interval downlink transmission is carried over a frequency band used for uplink reception in a contiguously preceding transmit time interval.

### BACKGROUND

Wireless communications, including wireless networks, have become pervasive throughout society. Improvements in wireless communications are vital to increase their reliability, spectral efficiency and speed. Downlink transmissions in the presence of downlink channel knowledge at a base station in a wireless network may provide a significant boost to the downlink spectral efficiency as well as speed. “Speed” may be considered as related more to the per-user throughput experience and “spectral efficiency” may be related to an operator's ability to deliver as many bits as possible in a specified amount of time. Improvements are needed for both “speed” and spectral efficiency. To facilitate implementation of wireless communication standards, the Institute of Electrical and Electronic Engineers (IEEE) has developed standards and protocols for such communication networks. These standards are commonly referred to as the IEEE standards, although it is clearly understood that the present invention is not limited to IEEE standards. The recent sounding mechanism available in the IEEE 802.16e standard is perhaps the beginning of penetration of such techniques into practical standards. The sounding mechanism in IEEE 802.16e enables downlink channel estimation at the base by exploitation of the time division duplexing (TDD) reciprocity. Another optional mechanism in IEEE 802.16e, called “direct transmission”, provides the base station with the downlink channel knowledge by explicit uplink transmission containing an estimation of the downlink channel by the mobile.

While the “direct transmission” is valid for time division duplexing (TDD) as well as for frequency division duplexing (FDD), it does have some important disadvantages compared to the sounding mechanism that relies on TDD reciprocity: First, an estimation of the downlink channel per antenna of the base station is required and therefore a proper pilot pattern, sampling each antenna of the base station, is required in the downlink signal in order to make this information available to a mobile station. Second, the amount of data fed back to the base station is linearly proportional to the number of antennas at the base station. These are in contrast with the mechanism that relies on TDD reciprocity, where no special pilot is required per antenna and the amount of feedback is independent of the number of antennas at the base station.

Thus, a strong need exists for an improved apparatus, system and method capable of feedback that enables downlink transmissions with channel knowledge at a base station

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the uplink (UL) and downlink (DL) either of which may be for frequencies f₀ and f₁ of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless metropolitan area networks (WMAN), wireless local area networks (WLAN), personal area networks (PAN, and the like).

An embodiment of the present invention provides a duplexing manner that relies on two simultaneously transmitting frequencies (thus it is FDD in nature) allowing for a sounding mechanism that provides the base station with downlink channel knowledge based on pilots (relying on TDD reciprocity)—although two frequencies are illustrated herein, it is understood that the present invention is not limited to only two frequencies or specific frequencies. In addition, the proposed method may be highly suitable for wireless communications, providing the coding with channel state information at the transmitter (CSIT) some of the FDD advantages that are uncommon for TDD systems.

The transmission scheme of an embodiment of the present invention may provide that 2 frequency bands are assigned to the system (this may be a typical situation in an FDD environment) but the two bands are not defined as “uplink” and “downlink”. Rather, once per transmit time interval (TTI, for example a frame in the WiMAX terminology—although the present invention is not limited to any particular wireless communication techniques) the frequency carrier changes it role—once it is an uplink carrier and once it is a downlink carrier and continuing periodically. In a sense, the system may be conceived as two TDD systems; however the new duplexing method is not equivalent to 2 TDD systems operating simultaneously, as a response to the transmission on one carrier can be sent over the other carrier within the same TTI. Again, more than 2 frequency bands may be used in an embodiment of the present invention and the uplink transmission on one band at a certain TTI may be followed by downlink transmission on the same band at the next TTI, although the present invention is not limited in this respect. In an embodiment of the present invention, how and where the uplink transmissions hop among the available bands from one TTI to another may be irrelevant. Further, multiple bands may be used for frequency hopping (so that transmission is effectively carried over two bands at all times) or for multi-carrier streaming (so that more than one uplink stream is available).

An illustrative example, although not limited in this respect, is how the sounding mechanism is supported by the present invention. Sounding may be defined as a mechanism transmitting training sequences allowing the receiver to estimate the impulse response of the channel. Here, one or more “uplink” sounding symbols may be transmitted over one carrier (assume it is f₀). The base station is therefore able to measure the channel transfer function over the carrier f₀. Then, in the next TTI, the carrier f₀ becomes a “downlink” platform and the base station already knows its characteristics from the previous TTI estimation (as by reciprocity over the same carrier the channels are the same). The channel may vary in time, so its estimation based on the previous TTI may become inaccurate or even obsolete, where the latter case typically relates to high mobile velocities. However, the base station algorithms may take this fact into account and will address the channel knowledge with the proper treatment. In particular, for low mobility it is true that the channel variation is very small.

Moreover, by transmitting some dedicated pilots over the carrier f₀ (possibly with, although not limited to, proper beamforming at the base station), the mobile is able to estimate its signal to noise ration (SINR) corresponding to this transmission and provide nearly immediate feedback to the base station (over the carrier f₁) with this SINR estimated value (or a channel quality indicator based on this value. Although SINR or SNR are reasonable parameters, it is understood the the present invention may utilize not only SNR but any feedback on any channel quality indicator, Thus, the base station may adapt its modulation and coding scheme (MCS) within the same TTI and this adaptation is relevant to the same beamforming in the “home” sector as well as to the same interference arriving at the mobile from other sectors. The ability of a mobile to respond to a base station transmission within the same TTI is beyond what is possible in TDD environment.

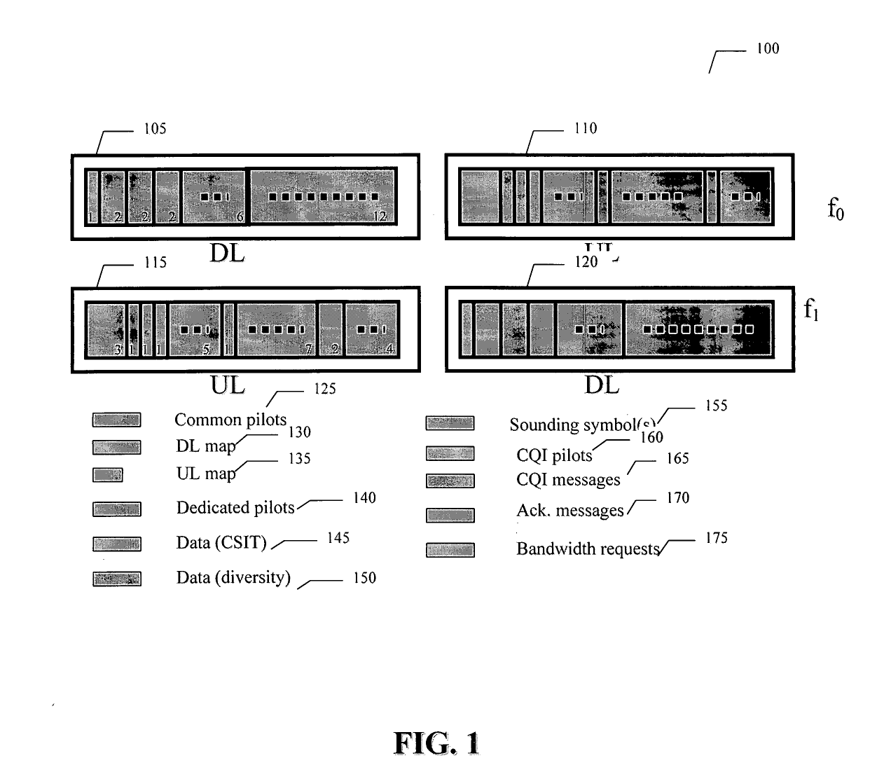

Turning now to FIG, 1, shown generally at 100, is a frame structure for uplink (UL) 110 and 115 and downlink (DL) 105 and 120 for frequencies f₀ and f₁ of one embodiment of the present invention. The frames may include in an illustrative example and not by way of limitation: common pilots 125, DL Map 130, UL Map 135, Dedicated pilots 140, Data generated by the help of CSIT (i.e., sounding) 145, Data generated without the help of CSIT (typically aiming at enough diversity) 150, sounding symbols 155, CQI pilots 160, CQI messages 165, Acknowledgement messages 170, and Bandwidth requests 170. It is understood that while FIG. 1 is illustrative of “OFDM” modulation, the present invention is not limited to OFDM or any particular modulation techniques.

FIG. 1 also demonstrates that with the scheme of an embodiment of the present invention, some mobiles may be served based on the channel knowledge while some other mobiles may be served not based on such information (relying merely on diversity methods). Again, it is understood that while FIG. 1 may be characterizing a specific frame structure, it contains some elements that are not essential to the present invention such as, but not limited to, the location in which acknowledgement messages are sent.

As explained above, the invention allows for feedback that enables downlink transmission with channel knowledge at the base station, while the feedback is independent of the number of antennas at the base station and does not require pilot signals per antenna of the base station. Moreover, the present invention allows for very fast link adaptation that may rely on channel estimation at the mobile with respect to a fixed beamformer set within the same TTI and in correspondence to the downlink channel knowledge. Further, the present invention also provides that the beamformers may be fixed for all surrounding sectors as well.

An embodiment of the present invention further provides a system, comprising a mobile station capable of communicating with a base station, wherein the mobile station is capable of responding to the base station transmission within the same transmit time interval (TTI) by using frequency division duplexing (FDD) thereby allowing for a sounding that provides the base station with downlink channel knowledge based on pilots; and wherein once per transmit time interval a frequency carrier may change it role such that once it is an uplink carrier and once it is a downlink carrier and continuing periodically. In this invention we essentially identify FDD as two bands serving for uplink and downlink simultaneous transmissions, with frequency separation but without fixing the identity of each band as being either uplink or downlink. As a response to a transmission on one carrier, another transmission can be sent over the other carrier within the same transmit time interval and the base station is capable of measuring the channel transfer function over a carrier and during a next transmit time interval (TTI) the carrier becomes a “downlink” platform and the base station already knows its characteristics from the previous TTI estimation.

Yet another embodiment of the present invention provides an article comprising a machine-accessible medium having one or more associated instructions, which if executed, results in obtaining downlink channel knowledge by a base station based on pilots in a duplexing manner by using two simultaneously transmitting frequencies that allow for channel sounding. The present article may further control changing once per transmit time interval by a frequency carrier its role, such that once it is an uplink carrier and once it is a downlink carrier and continuing periodically and sending a response to a transmission on one carrier and sending another transmission over the other carrier within the same transmit time interval.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a base station employing a duplexing technique that allows simultaneous transmission and reception on a plurality of frequency bands, such that each transmit time interval of downlink transmission is carried over a frequency band used for uplink reception in a contiguously preceding transmit time interval.

2. The apparatus of claim 1, wherein said plurality of frequency bands is two frequency bands.

3. The apparatus of claim 1, wherein said each transmit time interval of downlink transmission is carried over a frequency band used for uplink reception in a contiguously preceding transmit time interval is done in a periodic time interval.

4. The apparatus of claim 1, wherein downlink channel knowledge for a certain frequency band and a certain transmit time interval is obtained based on training signals transmitted in a contiguously preceding time interval in said uplink and on said frequency band.

5. The apparatus of claim 1, wherein reception of information on one carrier is obtained as a feedback for transmission of signals over another carrier within the same transmit time interval

6. The apparatus of claim 1, wherein said duplexing technique involves multiple carriers for uplink as well as multiple carriers for downlink.

7. The apparatus of claim 1, wherein said duplexing technique instantaneously selects uplink and downlink bands out of a larger pool of available bands.

8. The apparatus of claim 1, further comprising fixed frequency bands dedicated for transmission of downlink control messaging.

9. The apparatus of claim 1, wherein said base station is capable of measuring the channel transfer function over a carrier and during a next transmit time interval (TTI) said carrier becomes a “downlink” platform wherein said transfer function is affecting transmitted signals from said base station within said downlink transmit time interval.

10. The apparatus of claim 1, wherein by transmitting some dedicated pilots over a carrier, a mobile station is capable of estimating its Signal to Interference plus Noise Ratio corresponding to this transmission and providing feedback to said base station within the same TTI.

11. The apparatus of claim 10, wherein said base station is capable of adapting its modulation and coding scheme (MCS) within the same TTI.

12. The apparatus of claim 11, wherein said adaptation of said modulation and said coding scheme is relevant to the same beamforming in a “home” sector as well as to the same interference arriving at the mobile from other sectors.

13. A system, comprising:
a mobile station capable of communicating with a base station, wherein said base station is capable of employing a duplexing technique that allows simultaneous transmission and reception on a plurality of frequency bands, such that each transmit time interval downlink transmission is carried over a frequency band used for uplink reception in a contiguously preceding transmit time interval.

14. The system of claim 13, wherein said plurality of frequency bands is two frequency bands.

15. The system of claim 13, wherein said each transmit time interval of downlink transmission is carried over a frequency band used for uplink reception in a contiguously preceding transmit time interval is done in a periodic time interval.

16. The system of claim 13, wherein downlink channel knowledge for a certain frequency band and a certain transmit time interval is obtained based on training signals transmitted in a contiguously preceding time interval in said uplink and on said frequency band.

17. The system of claim 13, wherein reception of information on one carrier is obtained as a feedback for transmission of signals over another carrier within the same transmit time interval.

18. The system of claim 13, wherein said duplexing technique involves multiple carriers for uplink as well as multiple carriers for downlink.

19. A method, comprising:
employing a duplexing technique by a base station that allows simultaneous transmission and reception on a plurality of frequency bands, such that each transmit time interval downlink transmission is carried over a frequency band used for uplink reception in a contiguously preceding transmit time interval.

20. The method of claim 19, further comprising employing two frequency bands.

21. The method of claim 19, wherein said each transmit time interval downlink transmission carried over a frequency band used for uplink reception in a contiguously preceding transmit time interval is done in a periodic time interval.

22. The method of claim 19, further comprising obtaining downlink channel knowledge for a certain frequency band and a certain transmit time interval based on training signals transmitted in a contiguously preceding time interval in said uplink and on said frequency band.

23. The method of claim 19, further comprising obtaining as a feedback for transmission of signals over another carrier within the same transmit time interval by reception of information on one carrier.

24. An article comprising a machine-accessible medium having one or more associated instructions, which if executed, results in the implementation of a duplexing technique by a base station that allows simultaneous transmission and reception on a plurality of frequency bands, such that each transmit time interval downlink transmission is carried over a frequency band used for uplink reception in a contiguously preceding transmit time interval.

25. The article of claim 24, further comprising employing two frequency bands.

26. The article of claim 25, wherein said each transmit time interval downlink transmission carried over a frequency band used for uplink reception in a contiguously preceding transmit time interval is done in a periodic time interval.

27. The article of claim 24, further comprising obtaining downlink channel knowledge for a certain frequency band and a certain transmit time interval based on training signals transmitted in a contiguously preceding time interval in said uplink and on said frequency band.

28. The article of claim 24, further comprising obtaining as a feedback for transmission of signals over another carrier within the same transmit time interval by reception of information on one carrier.
